(19) United States
(12) Patent Application Publication
(10) Pub. No.: US 2009/0085858 A1
(43) Pub. Date: Apr. 2, 2009

(54) DRIVING CIRCUIT AND RELATED DRIVING METHOD OF DISPLAY PANEL

(76) Inventors: Chun-Yuan Hsu, Taipei County (TW); Chih-Jen Shih, Changhua County (TW); Che-Cheng Kuo, Taoyuan County (TW); Cheng-Hung Tsai, Changhua County (TW); I-Cheng Shih, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/927,697

(22) Filed: Oct. 30, 2007

(30) Foreign Application Priority Data
Sep. 27, 2007 (TW) 096136005

(51) Int. Cl. G09G 3/36

(52) U.S. Cl. 345/100

(57) ABSTRACT

A driving circuit applied to a display panel includes a driving unit for generating a plurality of driving signals to drive a plurality of pixels in the display panel, and a plurality of multiplexers coupled to the driving unit and the plurality of pixels. Each multiplexer of the plurality of multiplexers is utilized for sequentially transmitting a plurality of driving signals to a plurality of sub-pixels of a corresponding pixel, where two adjacent pixels utilize different driving sequences of the sub-pixels to drive their sub-pixels.

### BACKGROUND OF THE INVENTION

1. Field of the Invention

The present invention relates to a driving circuit applied to a display panel, and more particularly, to a driving circuit built on a low temperature polycrystalline silicon (LTPS) liquid crystal display (LCD) panel and comprising multiplexers and related driving method.

2. Description of the Prior Art

Please refer to FIG. 1. FIG. 1 shows a prior art LTPS-LCD system 100. The LTPS-LCD system 100 comprises a display panel 110, a data driver 120, a timing controller 130, and a memory unit 140. In addition, the display panel 110 further comprises a scan driver 112 and a multiplex circuit 114, where the scan driver 112 and the multiplex circuit 114 are built on the display panel 110.

As shown in FIG. 1, an external input signal is transformed to display data with a resolution required by the display panel 110 through a scaler board 150, and then the display data is transmitted to the timing controller 130. After the timing controller 130 receives required data from the scaler board 150 and the memory unit pre-storing a great quantity of the display data, control signals and the display data are transmitted to the scan driver 112 and the data driver 120.

FIG. 2 is a diagram illustrating the timing controller 130 transmitting the control signals to the scan driver 112 and the data driver 120 shown in FIG. 1. The control signals comprise driving control signals and display signals such as horizontal synchronizing signal HSYNC, an output enabled control signal OE, a red sub-pixel switch signal ASWR, a green sub-pixel switch signal ASWG, a blue sub-pixel switch signal ASWB, and a data signal DATA. As shown in FIG. 2, the red sub-pixel switch signal ASWR, the green sub-pixel switch signal ASWG, and the blue sub-pixel switch signal ASWB are transmitted sequentially, that is the driving sequence of the sub-pixels is red sub-pixel, green sub-pixel, and blue sub-pixel. In addition, when a next frame displays, the transmitted sequence of the control signal is also ASWR, ASWG, and ASWB.

FIG. 3 is a diagram illustrating the driving sequences of the sub-pixels in the display panel 110 shown in FIG. 1. To decrease the number of output ports of the data driver, the red, green, and blue sub-pixels of a pixel need to display sequentially by switching a plurality of multiplexers 114a, 114b, and 114c of the multiplex circuit 114. However, because of the parasitic capacitance and the parasitic resistance effects of the multiplexers 114a, 114b, and 114c, the red, green, and blue gamma curves are separated when the display panel 110 is driven. When the display panel 110 performs gamma correction, the large separation between the red, green, and blue gamma curves will result in difficulties in gray correction. Therefore, color deviations may happen on the display panel. FIG. 4 is a diagram illustrating red, green, and blue gamma curves when sequentially driving the red, green, and blue sub-pixels.

### SUMMARY OF THE INVENTION

It is an objective of the present invention to provide a driving circuit built on an LTPS-LCD panel and comprising multiplexers and related driving method, to solve the above-mentioned problems.

According to one embodiment of the present invention, a driving circuit applied to a display panel is provided. The driving circuit applied to a display panel comprises a driving unit for generating a plurality of driving signals to drive a plurality of pixels in the display panel, and a plurality of multiplexers coupled to the driving unit and the plurality of pixels. Each multiplexer of the plurality of multiplexers is utilized for sequentially transmitting a plurality of driving signals to a plurality of sub-pixels of a corresponding pixel, where two adjacent pixels utilize different driving sequences of the sub-pixels to drive their sub-pixels.

According to one embodiment of the present invention, a driving method applied to drive a display panel is further provided. The driving method applied to drive a display panel comprises generating a plurality of driving signals to drive a plurality of pixels in the display panel, utilizing a multiplexing process to sequentially transmit a plurality of driving signals for each pixel of the plurality of pixels to a corresponding plurality of sub-pixels, where two adjacent pixels utilize different driving sequences of the sub-pixels to drive their sub-pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art LTPS-LCD system.

FIG. 2 is a diagram illustrating the timing controller transmitting the control signals to the scan driver and the data driver shown in FIG. 1.

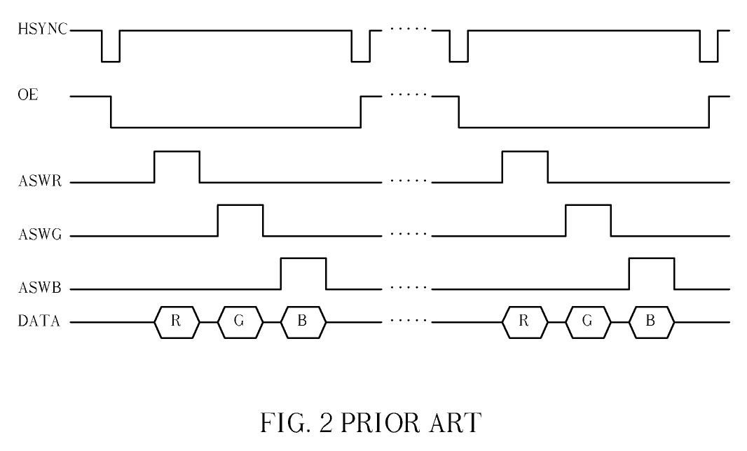

FIG. 3 is a diagram illustrating the driving sequences of the sub-pixels in the display panel shown in FIG. 1.

FIG. 4 is a diagram illustrating red, green, and blue gamma curves when sequentially driving the red, green, and blue sub-pixels.

FIG. 5 is a diagram illustrating a driving circuit applied to sub-pixels in a display panel according to one embodiment of the present invention.

FIG. 6 is the measured red, green, and blue gamma curves of the display panel utilizing the driving circuit of the present invention.

### DETAILED DESCRIPTION

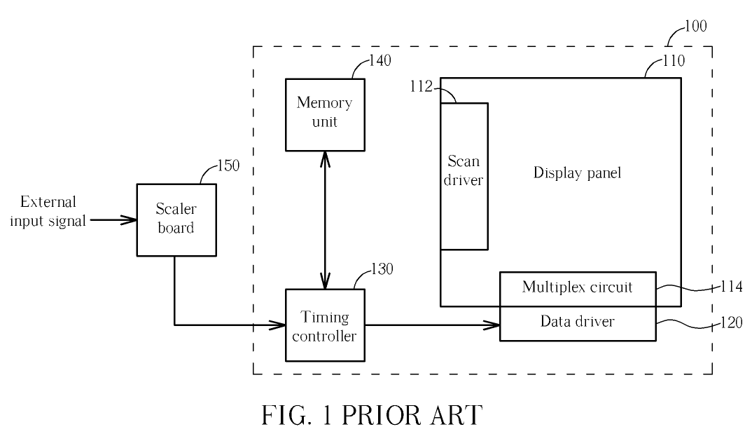

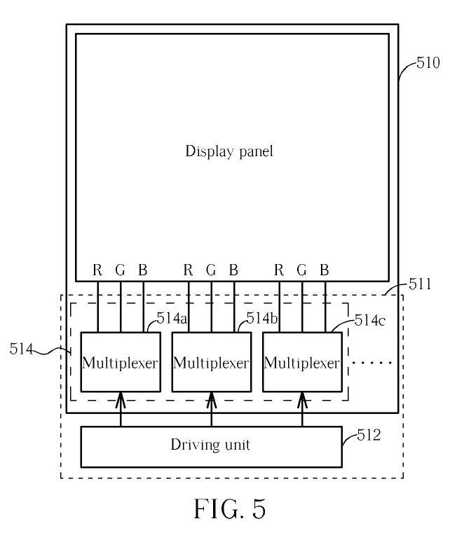

Please refer to FIG. 5. FIG. 5 is a diagram illustrating a driving circuit 511 applied to sub-pixels in a display panel 510 according to one embodiment of the present invention. In this embodiment, the driving circuit 511 comprises a driving unit 512 and a multiplex circuit 514, wherein the driving unit 512 is utilized to generate a plurality of driving signals to drive a plurality of pixels in the display panel 510, and the multiplex circuit 514 comprises a plurality of multiplexers 514a, 514b, and 514c. The display panel 510 shown in FIG. 5 can be applied to the LTPS-LCD panel system 100 shown in FIG. 1; that is, the display panel 510 replaces the display panel 110, the multiplex circuit 514 replaces the multiplex circuit 114, and the driving unit 512 replaces the data driver 120. As shown in FIG. 5, the plurality of multiplexers 514a, 514b, and 514c are built on the display panel 510, wherein each multiplexer (514a, 514b, and 514c) is coupled to a corresponding pixel, and is used for transmitting the driving signals received from the driving unit 512 to a plurality of sub-pixels of the corresponding pixel.

In this embodiment, a pixel comprises red, green, and blue sub-pixels, and each multiplexer (514a, 514b, and 514c) is serving as a switch for switching the connection between the three sub-pixels and the driving unit 512. Take the three adjacent multiplexers 514a, 514b, and 514c shown in FIG. 5 as an example: the driving sequence by which the multiplexer 514a drives the sub-pixels of the corresponding pixel is red (R), green (G), and blue (B); the driving sequence by which the multiplexer 514b drives the sub-pixels of the corresponding pixel is blue (B), green (G), and red (R); the driving sequence by which the multiplexer 514c drives the sub-pixels of the corresponding pixel is red (R), green (G), and blue (B). In other words, at a first driving period, the red sub-pixel of the pixel corresponding to the multiplexer 514a, the blue sub-pixel of the pixel corresponding to the multiplexer 514b, and the red sub-pixel of the pixel corresponding to the multiplexer 514c are driven at the same time. Next, at a second driving period, the green sub-pixels of the pixels respectively corresponding to the multiplexers 514a, 514b, and 514c are driven at the same time. Then, at a third driving period, the blue sub-pixel of the pixel corresponding to the multiplexer 514a, the red sub-pixel of the pixel corresponding to the multiplexer 514b, and the blue sub-pixel of the pixel corresponding to the multiplexer 514c are driven at the same time. Please note that the above-mentioned first driving period, second driving period, and third driving period are three continuous periods.

When the multiplexers 514a, 514b, and 514c respectively drive the sub-pixels of the corresponding pixels in sequence, because of the parasitic capacitance and the parasitic resistance effects of the multiplexers 514a, 514b, and 514c, the voltage level of a sub-pixel is varied when the driving signals of another sub-pixel are transmitted from the driving unit 512 to the multiplexers 514a, 514b, and 514c. Taking the multiplexer 514a as an example, at the first driving period, the multiplexer 514a transmits the driving signal to the red sub-pixel; at the second driving period, the multiplexer 514a transmits the driving signal to the green sub-pixel. At this time, because of the parasitic capacitance and the parasitic resistance effects of the multiplexers 514a, the voltage level of the red sub-pixel is varied. At the third driving period, also because of the parasitic capacitance and the parasitic resistance effects of the multiplexers 514a, the voltage levels of the green sub-pixel and the red sub-pixel are varied. In summary, the voltage levels of the sub-pixels driven at the first and second driving periods are all varied due to the parasitic capacitance and the parasitic resistance effects.

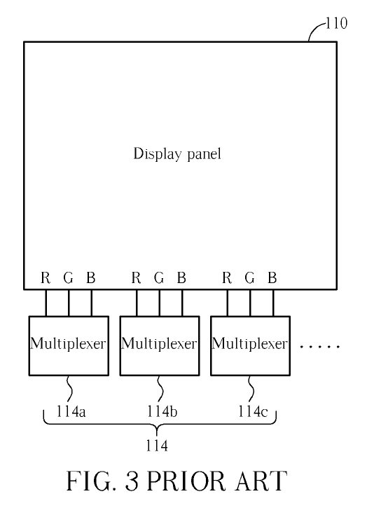

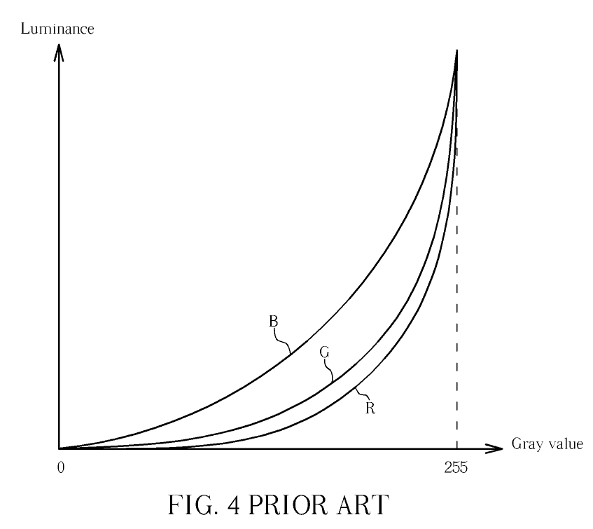

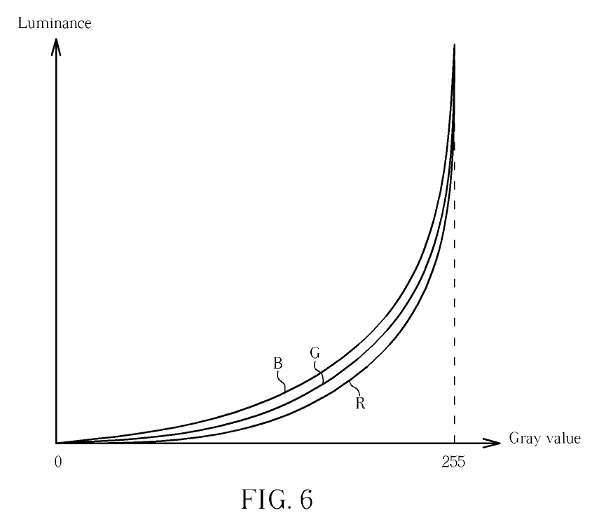

Therefore, in the prior art driving sequence of the sub-pixels of the display panel shown in FIG. 3, because the driving sequence of each sub-pixel is red, green, and blue sub-pixels, the voltage levels of all the red sub-pixels and the green sub-pixels are influenced and varied. The gamma curve separation phenomenon shown in FIG. 4 therefore occurs. In the driving mechanism shown in FIG. 5, however, the driving sequence of the sub-pixels of the pixel corresponding to the multiplexer 514a is red, green, and blue sub-pixels, and the voltage level of the red and the green sub-pixels are therefore varied; by the same token, the driving sequence of the sub-pixels of the pixel corresponding to the multiplexer 514b is blue, green, and red sub-pixels, and the voltage levels of the blue and the green sub-pixels are therefore also varied. As a result, after averaging the light over the whole panel, the gamma curve separation phenomenon can be improved according to the special driving sequence of the sub-pixels provided by this embodiment. FIG. 6 is the measured red, green, and blue gamma curves of the display panel utilizing the driving circuit of the present invention. Compared with the measured red, green, and blue gamma curves of the prior art driving circuit shown in FIG. 4, the gamma curve separation phenomenon is indeed improved by applying the driving circuit of the embodiment of the present invention.

In the present invention, the driving method in those two adjacent pixels use sub-pixel driving sequences reversed from each other, which is a preferred embodiment. However, it is not meant to limit the present invention. For example, the gamma curve separation phenomenon also can be improved when the driving method in those two adjacent pixels uses different driving sequences of the sub-pixels; this alternative design is also within the scope of the present invention.

The driving method applied to drive the display panel of the present invention is summarized as follows. First, generating a plurality of driving signals to drive a plurality of pixels in the display panel. Then, for each pixel of the plurality of pixels, utilizing a multiplexing process to sequentially transmit a plurality of driving signals to a corresponding plurality of sub-pixels, where two adjacent pixels utilize different driving sequences of the sub-pixels to drive their sub-pixels.

Generally speaking, in the LTPS-LCD panel, one multiplexer corresponds to a pixel. However, by changing designs of the multiplexers, a multiplexer can correspond to a plurality of pixels having the same driving sequence of sub-pixels. As long as the two adjacent pixels use different driving sequences of the sub-pixels to respectively drive their sub-pixels, these designs are still within the scope of the present invention.

Those skilled in the art will readily observe that numerous modifications and alterations of the device and method may be made while retaining the teachings of the invention.

What is claimed is:

1. A driving circuit applied to a display panel, comprising:
a driving unit, for generating a plurality of driving signals to drive a plurality of pixels in the display panel;
a plurality of multiplexers, coupled to the driving unit and the plurality of pixels, wherein each multiplexer of the plurality of multiplexers is utilized for sequentially transmitting a plurality of driving signals to a plurality of sub-pixels of a corresponding pixel, where two adjacent pixels are driven by utilizing different driving sequences of the sub-pixels to drive their sub-pixels.

2. The driving circuit of claim 1, wherein the display panel is a low temperature polycrystalline silicon (LTPS) liquid crystal display (LCD).

3. The driving circuit of claim 1, wherein the driving sequence of a pixel is reversed from a driving sequence of an adjacent pixel.

4. The driving circuit of claim 3, wherein the plurality of sub-pixels of each pixel comprises a red sub-pixel, a green sub-pixel, and a blue sub-pixel; and in the driving sequences of the sub-pixels of two adjacent pixels, one driving sequence of the sub-pixels sequentially drives a red sub-pixel, a green sub-pixel, and a blue sub-pixel of a pixel, and another driving sequence of the sub-pixels sequentially drives a blue sub-pixel, a green sub-pixel, and a red sub-pixel of a pixel.

5. A driving method applied to drive a display panel, comprising: generating a plurality of driving signals to drive a plurality of pixels in the display panel; for each of the plurality of pixels, utilizing a multiplexing process to sequentially transmit a plurality of driving signals to a corresponding plurality of sub-pixels, where two adjacent pixels are driven by utilizing different driving sequences of the sub-pixels to drive their sub-pixels.

6. The driving method of claim 5, wherein the display panel is a low temperature polycrystalline silicon (LTPS) liquid crystal display (LCD).

7. The driving method of claim 5, wherein the driving sequence of a pixel is reversed from a driving sequence of an adjacent pixel.

8. The driving method of claim 7, wherein the plurality of sub-pixels of each pixel comprises a red sub-pixel, a green sub-pixel, and a blue sub-pixel; and in the driving sequences of the sub-pixels of two adjacent pixels, one driving sequence of the sub-pixels sequentially drives a red sub-pixel, a green sub-pixel, and a blue sub-pixel of a pixel, and another driving sequence of the sub-pixels sequentially drives a blue sub-pixel, a green sub-pixel, and a red sub-pixel of a pixel.
